(19) United States
(12) Patent Application Publication
(10) Pub. No.: US 2004/0089081 A1
(43) Pub. Date: May 13, 2004

(54) Method and device for monitoring underground installations

(76) Inventor: Axel Kretzschmar, Magdeburg (DE)

Correspondence Address: Law Office of Karl Hormann, P O Box 381516, Cambridge, MA, 02238-1516, US

(21) Appl. No.: 10/468,325

(22) PCT Filed: Feb. 1, 2002
(86) PCT No.: PCT/DE02/00411

(30) Foreign Application Priority Data
Feb. 16, 2001 (DE) 101 07 260.0

(51) Int. Cl. G08B 17/10

(52) U.S. Cl. 73/866.1; 340/691.4; 340/540; 340/628

(57) ABSTRACT

The invention relates to a method and apparatus for monitoring underground installations in which natural or forced flows are prevailing, such as tunnels, passages, canals, and the like, by at least sectional detection and evaluation of changing physical and/or chemical characteristings over the entire length of the installation to be monitored, whereby an alarm is released in case an admissible parameter is exceeded.

The object of the invention is to provide a method of monitoring an underground installation which makes possible a high degree of reliability at reasonable economic expense. In particular, a quick and spatially precise localization is to be possible. In the device reuired therefor, simple and robust detectors are to be used.

In accordance with the invention the physical and/or chemical characteristics are detected and evaluated in each section transversely of the flow (7) of air over the structural clearance profile of the underground installation. For this purpose the sensors and/or suction nozzles (4, 8) in each section are arranged over the structural clearance profile of the underground installation in a plane transversely of the flow (7) of the air.

The invention relates to a method and apparatus for monitoring underground installations which are subject to natural or forced flows, such as tunnels, passages, canals, and the like.

To ensure high safety standards of underground traffic installations, extinguishing equipment installed therein must be released by fire alarm devices in order to limit or prevent the spread of the fire early, i.e. during its development phase already. For this purpose it is known to install detectors along the ceiling of a tunnel. For instance, in the ADW 511 Transafe system, the linear heat detector, a copper sensing tube filled with a gas, is installed along the ceiling of a tunnel. The change in pressure caused by localized heating is immediately sensed by an electronic pressure receiver connected to an end of the tube (homepage/website of SecuriSens Company). To prevent false measurements, the pressure extant in the tube must be monitored continuously. To this end, a test motor is provided which at regular intervals generates a predetermined super pressure in the tube. The actual pressure increase is compared with this pressure which serves quasi as a reference parameter measurement value. In case of deviations of the measured pressure from the test pressure a signal is released. The necessary test motor as well as the procedure require an additional effort.

The heat sensor cable TSC 511 which has become known by way of the website of the SecuriSens Company as well, is based on a similar principle. In this case the installation also extends over long measuring distances. Regularly monitored small temperature sensors are applied to a shielded flat ribbon cable which serves as a data and storage bus. Based upon predetermined values, an evaluation circuit decides when a signal has to be released in response to an inadmissibly high heat increase.

The disadvantage of those two thermal monitoring processes is that they require relative dear line alarms. It is also known from practical experience that signaling a localized increase in temperature near the ceiling of a tunnel is unsuitable for an early detection of a fire since at the time the signal is released the fire may already have spread in a hazardous way. Moreover, the unpredictable flow conditions prevailing in a tunnel do not admit of a reliable localized fire detection.

It has also become known to install suction nozzles along the ceiling of a tunnel. The air sucked in by these nozzles is fed to detectors which examine the air for fire, smoke and toxic gasses. In case a maximum concentration is exceeded, an alarm signal is dispatched to a monitoring center, and an extinguishing device is activated. Such smoke suction systems are being offered, for instance, by prospectus sheets of the company Wagner Alarm und Sicherungssysteme GmbH. of Langenhagen. However, practical applications have demonstrated the unreliability of such fire alarm systems. As set forth in the article of Siemens, Cerberus Division, Maenndorf, Switzerland, the reasons for this must be sought chiefly in the unpredictability of flow conditions of the kind prevailing in underground traffic systems (Maergele, R., “Branddetektion und Loeschung von Tunnelbraenden im Test”, S+S Report, Febuary 2000, pp. 36-41). As a consequence, alarms are released too late and locally very imprecise. A further disadvantage of such fire alarm techniques is that very dear detectors are used for distinguishing fire and smoke gasses from fog and common automotive exhaust emissions for preventing false alarms. In practical applications the installation density of such detectors is kept very low for reasons of costs. Consequently, the site where the fire develops cannot be determined accurately. For a safe constriction of a fire it must, however, be localized with a precision of but a few meters.

For limiting false alarms of fire extinguishers, it has been proposed initially to connect signals released by smoke gas detectors to command centers which are monitored by trained operators. Following an examination by the operators, they are to make a decision about releasing the extinguishing system. Not only would such an approach be extremely expensive, but because of subjective erroneous assumptions it would be subject to too high a risk.

Fire detection which is more reliable and, above all, independent of flows prevailing in a tunnel is to be made possible by a heat detector system also linearly installed in a tunnel. A laser pulse propagating through a fiber-optical cable is changed as a result of partial warming of the cable. Since as stated in the publication referred to above (see page 41, top of column 1) the rising temperature of the cable is cause solely by the radiation heat of the fire which is not affected by wind in the tunnel, the site of the fire may be determined accurately. However, the disadvantage of such fire alarm cable in real traffic systems, even without test results, is obvious: Because of its complicated structure and because of its components, the cable is very expensive and it is combustible. Moreover, the evaluation of the signals and the localizing of the fire requires complex software.

The object of the invention is, therefore, the provide a method of monitoring underground installations which at an economically responsible cost offers a high degree of reliability. It is to make possible quick detection and spatially precise localization of fires as well as an accurate distinction, when using gas detectors, of smoke and fire gasses from vehicle emission gasses. Simple and robust detectors are to be used in the devices required for this purpose. Finally, the requirements as regards evaluation software, relative to the approaches referred to above, are to be significantly lower.

In accordance with the invention, the object is accomplished by the elements of patent claim 1. Patent claims 2 to 4 present advantageous procedural ways. Patent claim 5 relates to an apparatus for monitoring underground installations in which the measuring plane is arranged transversely of the flow direction of the air. The following patent claims 6 and 7 relate to defined arrangements of detectors within the measuring plane.

The new method meets the requirement of detecting and precisely locating, as quickly as possible, any impermissible change in the physical or chemical properties of air within the underground installation. In this connection, the way in which the detection is carried out is unimportant. By the detection in accordance with the invention transversely of the direction of air flow, the detector or detector positioned closest to the cause of the change will provide the decisive contribution to the sum signal detected by integration over the entire plane. Even higher wind velocities will be without essential effect as regards the detection since the detectors are not only arranged at the ceiling but also in the area of the walls and of the floor of the structural system. The invention offers the additional advantage that in the case of an installation of individual detectors relative unsensitive and, hence, inexpensive detectors may be used, such as, for instance, optical detectors, which deliver a signal only upon reaching a predetermined status. In the case of smoke detectors installed along the structural clearance profile it is no longer their high sensitivity which matters, but simply the response of the detectors reached by the smoke gas. These detectors need not be capable of distinguishing between automotive emissions gasses and truly dangerous smoke gasses. By integrating all detectors disposed within a measuring plane, information can be obtained about toxic gas relative to a predetermined and spatially precisely defined cross-section of the system. The sum signal obtained makes it possible to distinguish, without any difficulties, between a short-time localized and quickly dissipating eruption of vehicular emission gasses and a continuous or increasing emission of combustion gasses. Even though all changes in physical and/or chemical properties are, of course, registered, exclusively spot-like changes of the properties do not initially release a signal. Thus, a short-time response of individual detectors does not release a false alarm.

An economically particularly advantageous variant of the invention resides in the installation of suction nozzles or openings distributed in a manner appropriate for prevailing flow conditions, for continuously sucking in air. The mixture resulting from the sum of the air sucked in by all of the nozzles is compared with a threshold value by way of a detection and evaluation device provided in every measuring plane. For this purpose, the detector may be of simple structure since it need signal only different concentrations of a toxic gas in the suck-in air, rather than their composition. Such detectors need not be of high sensitivity. They only release a signal, if the concentration of a toxic gas in the sucked-in air exceeds the set threshold value. It is important that the evaluation circuit which has been reached by the air-toxic gas mixture, recognizes it as such. By arranging suction nozzles in the area of the floor of the underground installation it is possible to detect toxic gases the density of which is greater than air. Since the set threshold value is only exceeded if several suction nozzles suck in toxic gas over a longer period of time or if, in case of a fire, smoke gas is sucked in by several nozzles in a short time, that is to say if an abrupt quantitative increase of toxic gas is detected, can hazardous gasses be safely distinguished from air changes caused by an increased traffic volume or a traffic jam. A locally high concentration of locally and temporally limited vehicular gas emissions registered by one or two detectors, does not reach the set integrated toxic gas threshold concentration. Thus, vehicular gas emissions can no longer release a false alarm. Since several measuring planes are distributed over the entire length of the underground installation, the site where the toxic gas emission is generated can be defined precisely.

The safety of underground installations can be increased further by arranging sensors in a measuring plane which detect different properties or by installing optical and thermal detectors in addition to suction nozzles. By using detectors which are more economical, subject to fewer malfunctions and less maintenance this can be done economically.

The invention will hereafter be explained in greater detail with reference to an embodiment. In the appurtenant drawings:

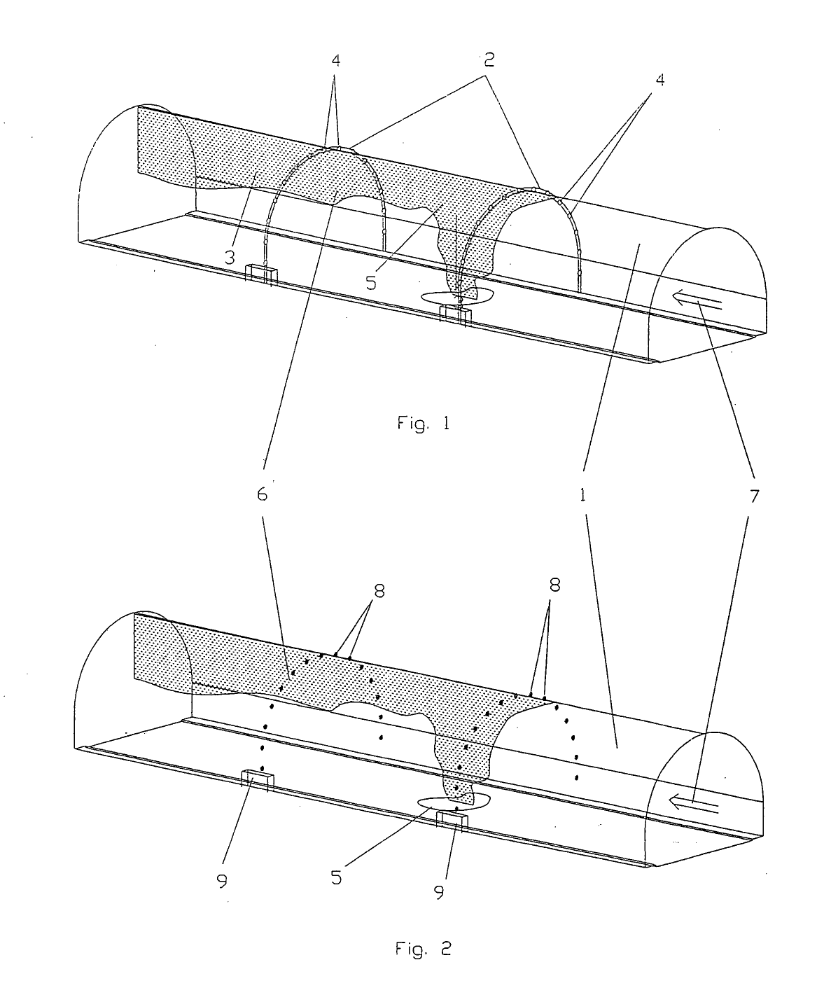

FIG. 1 is a schematic view of a fire alarm system in a tunnel, based on the principle of air suction;

FIG. 2 shows a fire alarm system based on the principle of sensors installed in a measuring plane; and

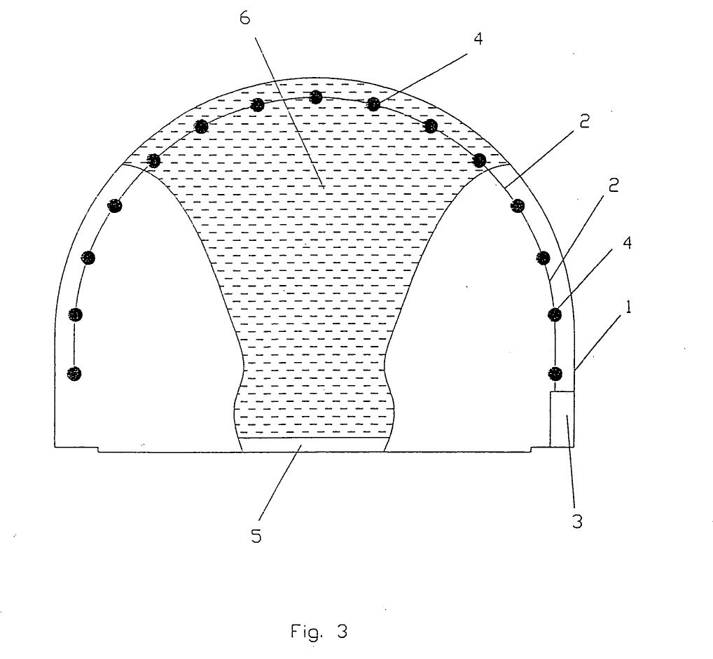

FIG. 3 is a cross-section of the tunnel of FIG. 1.

FIGS. 1 and 2 each depict a section of a traffic tunnel the structural clearance profile of which is limited by a vaulted tunnel wall 1. In FIG. 1, following the profile of the structural clearance, two tubular arches 2 are installed at a distance of about 50 m from each other, one tubular end of which enters into a detection device 3 not shown in detail. Suction openings 4 are disposed equally spaced along the circumference of the tubular arches. In terms of flow characteristics their opening diameters are such that at constant suction power the same flow volume per unit of time is sucked in at each opening. A fire 5 resulting in intensive smoke development is present on the floor of the traffic tunnel. The smoke 6 from the fire is spreading in the direction of the air flow 7 prevailing in the traffic tunnel and shown by an arrow. Whilst the suction openings 4 of the tubular arch 2 placed first in the direction of flow are still inhaling normal tunnel air, the air sucked into the consecutive tubular arch 2 already contains a considerable proportion of smoke. The section of the traffic tunnel disposed forwardly of the detecting tubular arch 2 will be indicated as the source of the smoke from the fire.

By way of difference from FIG. 1, FIG. 2 shows detectors 8 installed on the tunnel wall 1 instead of tubular arches 2. A signal line extends from each detector 8 to an evaluation unit 9 not shown in detail, where, depending upon the evaluation mode, the individual signals detected in a given measuring plane are integrated. The information thus gained is compared against a predetermined threshold value and if it is exceeded, an alarm signal will be released. The detectors 8 used may be of simple structure, such as optical detectors, smoke detectors or temperature detectors. Since each of them only signals a predetermined status, i.e. the presence of a defined physical or chemical condition, but no data about intensity, quality or admissibility of this condition, this variant also allows the use of simple and economical detectors. Only the integration of all values measured within a measuring plane delivers the desired information, i.e. data which is factually correct for a correct interpretation of the prevailing condition.

The essence of the invention becomes particularly apparent from the cross-sectional view of the tunnel shown in FIG. 3. In case of a fire, smoke 6 will collect under the ceiling of the tunnel within a short time. All suction openings 4 in tubular arches 2 disposed, in the direction of flow, in the area behind the fire 5, suck in the smoke 6. These suction openings 4 are more than one third of all the suction openings. The mixture of smoke and air arriving at the detector device 3 is immediately recognized as hazardous, so that an alarm will be released. By contrast, the gas emitted from an upwardly directed exhaust pipe of a truck will be sucked in along the entire length of the tunnel by but one or two suction openings 4, so that the air-emission gas mixture does not attain the critical concentration necessary to release an alarm.

The same holds true if, as shown in FIG. 2, detectors 8 are provided instead of suction openings 4. The detectors 8 arranged at the highest point of the tunnel wall 1 act in the manner of a linear detector along the entire length of the tunnel. Detors 8 successively responding at short intervals over the entire length of the tunnel indicate a passing vehicle with an upwardly directed exhaust pipe. If the gas is emitted downwardly laterally of the vehicle, the detector 8 in the immediate vicinity will deliver a signal, but the evaluation unit 9, by comparing the signal with other signals from the remaining detectors 8 disposed in the same measuring plane, will not release an alarm because of the small proportion of the signal relative to the total number of detectors 8.

1. A method of monitoring underground installations in which natural or forced flows are prevailing, such as tunnels, passages, canals and the like, by at least sectional detection and evaluation, over the entire length of the structure to be monitored, of physical and/or chemical characteristics in these installations changing relative to a condition defined as normal condition, for instance the temperature, the light conditions or the composition of the air, whereby a signal is released in case an admissible physical and/or chemical parameter is exceeded,
characterized by the fact
that the physical and/or chemical characteristics in each section are detected and evaluated transversely of the flow (7) of air over the structural clearance profile of the installation.

2. The method of claim 1,
characterized by the fact
that the physical and/or chemical characteristics are measured simultaneously at the ceiling, at the wall and/or in the area of the floor.

3. The method of claim 1,
characterized by the fact
that each individual measuring value relating to a measuring plane extending transversely of the direction of flow is compared against a threshold value.

4. The mthod of claim 1,
characterized by the fact
that a sum is formed from all measuring values relating to a measuring plane extending transversely of the direction of flow.

5. An apparatus for monitoring underground installations of great length in which natural or forced flows are prevailing, such as tunnels, passages, canals and the like, by sensors and/or suction nozzles arranged at least sectionally over the entire length of the structure to be monitored, for detecting physical and/or chemical characteristics in these installations, for instance the temperature, the light conditions or the composition of the air, and connected to an evaluation device
characterized by the fact
that the sensors and/or suction nozzles (4, 8) in each section are arranged over the structural clearance profile of the underground installation transversely of the flow of air.

6. The apparatus of claim 5,
charactyerized by the fact
that the sensors and/or the suction nozzles (4, 8) are uniformly arranged at least in sections of the ceiling, wall and/or floor area of the installation.

7. The apparatus of claim 5 and 6,
characterized by the fact
that in each measuring plane there are arranged sensors (8) which detect different characteristics.
